(19) United States
(12) Patent Application Publication
(10) Pub. No.: US 2025/0200718 A1
(43) Pub. Date: Jun. 19, 2025

(54) IMAGE ENHANCEMENT METHOD AND APPARATUS, DEVICE AND MEDIUM

(71) Applicant: Beijing Zitiao Network Technology Co., Ltd., Beijing (CN)

(72) Inventor: Yineng XIONG, Beijing (CN)

(21) Appl. No.: 18/846,237

(22) PCT Filed: Mar. 13, 2023
(86) PCT No.: PCT/CN2023/081019

§ 371 Date: Sep. 11, 2024

(30) Foreign Application Priority Data
Mar. 11, 2022 (CN) 202210239630.9

(51) Int. Cl. G06T 5/60; G06T 3/4046; G06T 5/20

(52) U.S. Cl. CPC G06T 5/60; G06T 3/4046; G06T 5/20; G06T 2207/20016; G06T 2207/20081; G06T 2207/20084

(57) ABSTRACT

The present disclosure relates to an image enhancement method, apparatus, device, and medium. The method includes: obtaining an initial image to be processed; inputting the initial image into an image enhancement model obtained by pre-training, wherein the image enhancement model comprises a multi-scale feature fusion network; performing a multi-scale feature extraction on an input image through the multi-scale feature fusion network to obtain initial feature maps of multiple scales, performing a fusion based on the initial feature maps of the multiple scales to obtain multiple intermediate feature maps, and performing a fusion based on the multiple intermediate feature maps to obtain an output feature map of the multi-scale feature fusion network, wherein the input image is obtained based on the initial image; and obtaining an image of which an image quality is enhanced based on the output feature map of the multi-scale feature fusion network and the initial image.

### CROSS-REFERENCE TO RELATED APPLICATIONS

The present disclosure is a U.S. National Stage Application under 35 U.S.C. § 371 of International Patent Application No. PCT/CN2023/081019, filed on Mar. 13, 2023, which is based on and claims priority of Chinese application for invention No. 202210239630.9 filed on Mar. 11, 2022, the disclosures of both of which are hereby incorporated into this disclosure by reference in their entireties.

### TECHNICAL FIELD

The present disclosure relates to the technical field of image processing, and in particular to an image enhancement method, apparatus, a device and a medium.

### BACKGROUND

Image enhancement technologies can improve a quality of an image and enhance a visual perception of the image, which is widely used in various image processing scenarios that need to improve the quality of the image.

In existing image enhancement technologies, there are mainly two methods: one is to enhance an image using a convolutional neural network algorithm with an encoder-decoder structure, and the other is to enhance an image using a transform based algorithm.

### SUMMARY

In a first aspect, an embodiment of the present disclosure provides an image enhancement method, which comprises: obtaining an initial image to be processed; inputting the initial image into an image enhancement model obtained by pre-training, wherein the image enhancement model comprises a multi-scale feature fusion network; performing a multi-scale feature extraction on an input image through the multi-scale feature fusion network to obtain initial feature maps of multiple scales, performing a fusion based on the initial feature maps of the multiple scales to obtain multiple intermediate feature maps, and performing a fusion based on the multiple intermediate feature maps to obtain an output feature map of the multi-scale feature fusion network, wherein the input image is obtained based on the initial image; and obtaining an image of which an image quality is enhanced based on the output feature map of the multi-scale feature fusion network and the initial image.

In a second aspect, an embodiment of the present disclosure also provides an image enhancement apparatus, comprising an image acquisition module configured to obtain an initial image to be processed; a model input module configured to input the initial image into an image enhancement model obtained by pre-training, wherein the image enhancement model comprises a multi-scale feature fusion network; a multi-scale fusion module configured to perform a multi-scale feature extraction on an input image through the multi-scale feature fusion network to obtain initial feature maps of multiple scales, perform a fusion based on the initial feature maps of the multiple scales to obtain multiple intermediate feature maps, and perform a fusion based on the multiple intermediate feature maps to obtain an output feature map of the multi-scale feature fusion network, wherein the input image is obtained based on the initial image; and an enhanced image acquisition module configured to obtain an image of which an image quality is enhanced based on the output feature map of the multi-scale feature fusion network and the initial image.

In a third aspect, an embodiment of the present disclosure also provides an electronic device, which comprises: a processor; a memory for storing executable instructions of the processor wherein the processor is configured to read the executable instructions from the memory, and execute the executable instructions to implement the image enhancement method provided in the embodiments of the present disclosure.

In a fourth aspect, an embodiment of the present disclosure also provides a computer-readable storage medium, wherein the storage medium stores computer programs, which when executed by a processor, cause the processor to execute the image enhancement method provided in the embodiments of the present disclosure.

It should be understood that what is described in this section is neither intended to identify key or important features of the embodiments of the present disclosure, nor is it intended to limit the scope of the present disclosure. Other features of the present disclosure will be readily understood from the following description.

### BRIEF DESCRIPTION OF THE DRAWINGS

The accompanying drawings herein are incorporated into the specification and form a part of this specification, illustrating embodiments of the present application and explaining the principles of the present disclosure together with the description.

In order to provide a clearer explanation of the technical solutions in the embodiments of the present disclosure or the prior art, a brief introduction will be given below to the accompanying drawings required by descriptions of the embodiments or the prior art. It is obvious for those skilled in the art that other drawings can be obtained based on these accompanying drawings without the need of creative labor.

FIG. 1 is a flowchart of an image enhancement method provided in some embodiments of the present disclosure.

FIG. 2 is an elementary diagram of a selective feature fusion module provided in some embodiments of the present disclosure.

FIG. 3 is an elementary diagram of an attention module provided in some embodiments of the present disclosure.

FIG. 4 is a structural diagram of a multi-scale feature fusion network provided in some embodiments of the present disclosure.

FIG. 5 is a schematic structural diagram of an image enhancement model provided in some embodiments of the present disclosure.

FIG. 6 is a schematic structural diagram of an image enhancement apparatus provided in some embodiments of the present disclosure.

FIG. 7 is a schematic structural diagram of an electronic device provided in some embodiments of the present disclosure.

### DETAILED DESCRIPTION

In order to understand the above objects, features and advantages of the present disclosure more clearly, schemes of the present disclosure will be further described below. It should be noted that if without a conflict, the embodiments of the present disclosure and features in the embodiments can be combined with each other.

In the following descriptions, many specific details are set forth in order to fully understand the present disclosure, but the present disclosure may be practiced in other ways than those described herein; obviously, the embodiments in the description are only part of the embodiments of the present disclosure, not all of them.

The inventor found that there are mainly two types of image enhancement algorithms in the prior art. The first type is a convolutional neural network algorithm with an encoder-decoder structure. This type of algorithm mainly extracts low-order and high-order features by performing a convolution and a down-sampling on an initial image with an encoder, and restores a spatial resolution by an up-sampling in a decoder, and generates an enhanced image pixel by pixel. Although this type of algorithm can be used for a variety of tasks end to end, it consumes giant computation and huge time, thereby difficult to be real-time, and requires frequent up-sampling and down-sampling, leading to an easy loss of details and a definition decrease in the enhanced image, consequently a quality of the enhanced image obtained is still unsatisfactory. The second type is a transform based algorithm, which usually first performs a down-sampling on an initial image, extracts features from a low-resolution image with a lightweight convolutional neural network structure, and then predicts transform coefficients of the low-resolution image, such as Affine Transform coefficients, etc., and then performs an up-sampling on the transform coefficients through an up-sampling method such as a bilateral grid, etc., to recover the transform coefficients of the whole image, which finally acts on the initial image to generate a final enhanced image. Although it is fast, the transform based algorithm has great limitations, poor learning ability and robustness, and is easy to amplify noise.

In order to improve at least one of the above problems, the embodiments of the present disclosure provide an image enhancement method and apparatus, a device and a medium, which will be elaborated below.

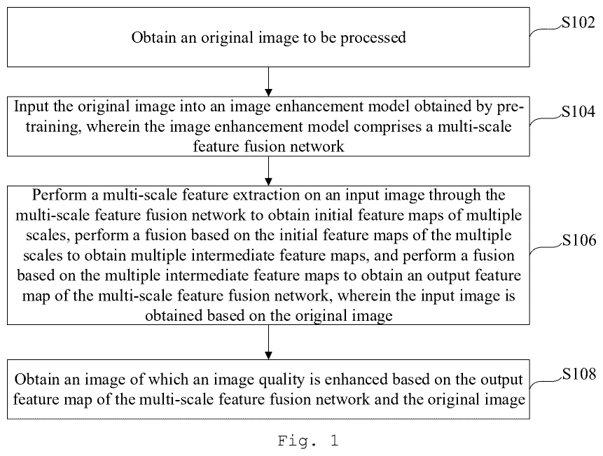

First of all, some embodiments of the present disclosure provide an image enhancement method, which can be executed by an image enhancement apparatus. The apparatus can be realized using software and/or hardware, and generally can be integrated in an electronic device. FIG. 1 is a flowchart of an image enhancement method provided in some embodiments of the present disclosure. The method mainly comprises the following steps S102˜S108.

In step S102, an initial image to be processed is obtained. The initial image is an image whose quality is to be improved. In the present embodiment of the disclosure, the acquisition method of the initial image is not limited. For example, an image captured by a camera can be directly used as the initial image to be processed, or an image uploaded by a user (or an image selected from an image library) can be used as the initial image to be processed.

In step S104, the initial image is input into an image enhancement model obtained by pre-training, wherein the image enhancement model comprises a multi-scale feature fusion network. In some embodiments, a number of the multi-scale feature fusion network is one or more, and when the number of the multi-scale feature fusion networks is more than one, the multiple multi-scale feature fusion networks are sequentially connected in series.

That is, the image enhancement model provided in some embodiments of the present disclosure can comprise N series-connected multi-scale feature fusion networks, where N is a positive integer, for example, can be 1, 2, 4, 16 or other numerical values. It can be understood that the smaller the numerical value of N, the shorter the image processing time of the image enhancement model, and the larger the numerical value of N, the better the image enhancement effect of the image enhancement model. In practical applications, the numerical value of N can be set according to requirements, which is not limited here.

In step S106, a multi-scale feature extraction is performed on an input image through the multi-scale feature fusion network to obtain initial feature maps of multiple scales, a fusion based on the initial feature maps of the multiple scales is performed to obtain multiple intermediate feature maps, and a fusion based on the multiple intermediate feature maps is performed to obtain an output feature map of the multi-scale feature fusion network, wherein the input image is obtained based on the initial image.

The input image of the multi-scale feature fusion network is obtained based on the initial image. In some embodiments, the input image of the multi-scale feature fusion network is the initial image, that is, the initial image is directly used as the input image. Or in other embodiments, the input image of the multi-scale feature fusion network is obtained after processing the initial image through a network module located in front of the multi-scale feature fusion network, that is, a processed image of the initial image is taken as the input image. The embodiments of the present disclosure do not restrict the network module located in front of the multi-scale feature fusion network. For example, the network module can be a preprocessing module formed by a convolutional layer, which can perform a preliminary feature extraction on the initial image in advance. For another example, the network module can be an image adjustment module, which can cut the initial image according to a preset size or adjust it according to a preset resolution. For another example, the network module is a multi-scale feature fusion network before the current multi-scale feature fusion network, and can perform many phases of multi-scale feature fusion on the initial image.

In some embodiments, the number of the multi-scale feature fusion networks is multiple, and the input image of the first multi-scale feature fusion network is obtained based on the initial image. For example, the input image of the first multi-scale feature fusion network is a feature map of the initial image obtained after convolution processing; the input image of a non-first multi-scale feature fusion network is obtained based on the output feature map of a previous multi-scale feature fusion network. For example, the input image of the non-first multi-scale feature fusion network can directly be the output feature map of the previous multi-scale feature fusion network, or can be obtained after performing an additional processing such as a convolution operation, etc., on the output feature map of the previous multi-scale feature fusion network.

The scale proposed in the embodiments of the present disclosure can be used to characterize a spatial resolution of a feature map. When performing the multi-scale feature extraction on the input image, a down-sampling method can be adopted. In particular by performing down-samplings in different multiples on the input image, the initial feature maps of the multiple scales are obtained. It can be understood that the initial feature maps of different scales focus on different feature information. For example, a small-scale down-sampling focus more on local features of an image, while a large-scale down-sampling focus more on global features of an image. Through the above multi-scale feature extraction method, features of an image can be extracted comprehensively and fully.

In addition, after extracting the initial feature maps of the multiple scales, the fusion is performed based on the initial feature maps of the multiple scales to obtain the multiple intermediate feature maps. Illustratively, the initial feature maps of the multiple scales are fused in different ways, so as to obtain the multiple intermediate feature maps; or, different initial feature maps are extracted from the initial feature maps of the multiple scales for fusion each time, so as to obtain multiple intermediate feature maps too. In this way, the multiple intermediate feature maps with different image features can be obtained, which is helpful to further extract richer and more comprehensive information.

In some embodiments, the multiple intermediate feature maps obtained through the fusion based on the initial feature maps of the multiple scales have different spatial resolutions. In a specific implementation, the initial feature maps of the multiple scales can be fused respectively under different scale branches to obtain an intermediate feature map corresponding to each of the scale branches. Each of the scale branches corresponds to one intermediate feature map, and different intermediate feature maps have different spatial resolutions. The intermediate feature map corresponding to each of the scale branches can also be called a branch feature map output by the scale branch correspondingly. In a practical application, the scale branches in the multi-scale feature fusion network corresponds to the scales of the initial feature maps.

For example, the multi-scale feature fusion network extracts initial feature maps of three scales from the input image (such as, an initial feature map with a spatial resolution that is same as the input image, an initial feature map with a spatial resolution that is half of the spatial resolution of the input image, and an initial feature map with a spatial resolution that is one quarter of the spatial resolution of the input image). Then correspondingly there are three scale branches, and inputs of the three scale branches are all the same, that is, the initial feature maps of the three scales, but the input initial feature maps are processed under different scales (spatial resolutions) respectively. For example, under a scale branch whose spatial resolution is same with that of the input image, the initial feature maps of the other two scales can be up-sampled to the scale with the same spatial resolution as the input image, and then fused.

That is, under each of the scale branches, the spatial resolutions of the initial feature maps of the multiple scales can be unified to the spatial resolution corresponding to the scale branch, and then processing can be carried out. Under different scale branches the initial feature maps of the multiple scales are processed in a same way, and each of the scale branches performs a fusion processing on the initial feature maps of the multiple scales according to a preset method to obtain the intermediate feature map of a scale corresponding to the each of the scale branches.

After obtaining the multiple intermediate feature maps, a further fusion can be performed based on the multiple intermediate feature maps to obtain the output feature map of the multi-scale feature fusion network. Since different intermediate feature maps can reflect different feature information, different intermediate feature maps are fused later, for example, the intermediate feature maps corresponding to different scale branches (that is, branch feature maps) are fused, and finally the output feature map obtained based on a fusion result can further fully represent image features, and retain original feature information at each spatial resolution.

In step S108, an image of which an image quality is enhanced (an image quality enhanced image) is obtained based on the output feature map of the multi-scale feature fusion network and the initial image. For example, the output feature map of the multi-scale feature fusion network can be fused with the initial image, so as to obtain the image of which the image quality is enhanced.

In some embodiments, a number of the multi-scale feature fusion networks is multiple, based on the output feature map of the last multi-scale feature fusion network and the initial image, a fusion can be performed and the image of which the image quality is enhanced can be obtained. Illustratively, the output feature map of the last multi-scale feature fusion network can be convolved to make its dimension consistent with that of the initial image, and then fused with the initial image through an element-wise sum fusion (Add processing) to obtain the image of which the image quality is enhanced.

Through the above step-by-step fusion method based on multi-scale features provided in the embodiments of the present disclosure, image features can be fully extracted and utilized, and the quality of the initial image can be effectively improved.

In some embodiments, although in the embodiments of the present disclosure multi-scale features can be extracted, the scales can be controlled and only feature maps with appropriate scales are extracted. In a specific implementation, when the multi-scale feature extraction is performed on the input image to obtain the initial feature maps of the multiple scales, the input image is down-sampled according to a plurality of preset multiples respectively to obtain the initial feature maps of the multiple scales, wherein the preset multiples are lower than a preset threshold. Illustratively, the preset multiples comprise one, two and four times, and based on this, the initial feature maps of three scales are obtained. Accordingly, the initial feature maps of the multiple scales comprise: the initial feature map with the spatial resolution that is same as the input image, the initial feature map with the spatial resolution that is half of the spatial resolution of the input image, and the initial feature map with the spatial resolution that is one quarter of the spatial resolution of the input image. By controlling the down-sampling in the above manner, compared with methods of 16 times down-sampling and the like in the related art, the embodiments of the present disclosure obtain the multi-scale features by down-sampling in a proper degree, and can retain original high-order features and an accurate spatial resolution, avoiding a loss of image details due to multiple down-samplings.

Fusing the initial feature maps of the multiple scales under different scale branches respectively to obtain the intermediate feature map corresponding to each of the scale branches can be implemented by referring to steps 1-2.

Step 1, a fusion processing is performed on the initial feature maps of the multiple scales based on a self-attention mechanism to obtain a multi-scale fusion map.

Step 2, the intermediate feature map corresponding to the target scale branch is obtained based on the multi-scale fusion map.

In the above manner, the each of the scale branches is taken as the target scale branch one by one, and the initial feature maps of the multiple scales are fused by using the self-attention mechanism, and finally the intermediate feature map corresponding to the each of the scale branches can be obtained. In a practical application, different scale branches can simultaneously process the initial feature maps of the multiple scales, and the processing methods are the same. That is, different scale branches comprise the same network structure. Difference of different scale branches is mainly reflected in scales (spatial resolutions), so the intermediate feature maps corresponding to different scale branches have different scales. Considering that traditional feature fusion methods, such as cascading features or adding features, etc., provide a network with limited expressive power, the embodiments of the present disclosure uses the self-attention mechanism to fuse the initial feature maps of the multiple scales, and can dynamically select features of different scales (features of multiple resolutions) for fusion according to information of the initial feature maps.

Specifically, the fusion of the initial feature maps of the multiple scales based on the self-attention mechanism can provide the initial feature maps of different scales with different weight values that are related to content of the input image, and different initial feature maps have different weight values. Therefore, the above-mentioned method can process the input image in a targeted way, and dynamically combine the initial feature maps of different scales to fuse based on content of the input image, so that finally obtained multi-scale fusion maps can more reliably reflect useful image features, and achieve an effect of dynamically combining variable receptive fields and retaining original feature information of each spatial resolution.

In some specific embodiments, fusing the initial feature maps of the multiple scales based on the self-attention mechanism, that is, the above step 1 can be implemented with reference to the following steps A to D.

Step A, scales of the initial feature maps of the multiple scales are unified to a scale corresponding to the target scale branch, and an element-wise sum fusion is performed on the initial feature maps after unifying scales to obtain an initial fusion map.

In some embodiments, the bilinear interpolation method can be used to unify the scales of the initial feature maps of the multiple scales to the scale corresponding to the target scale branch. Taking a spatial resolution of a feature map characterized by the scale corresponding to the target scale branch, which is half of the spatial resolution of the input image (that is, a scale of a feature map corresponding to twice down-sampling the input image), as an example, assuming that the initial feature maps of the multiple scales are respectively an initial feature map with a spatial resolution that is same as the input image, an initial feature map with a spatial resolution that is half of the spatial resolution of the input image, and an initial feature map with a spatial resolution that is one quarter of the spatial resolution of the input image, the initial feature map with the same spatial resolution as the input image is twice down-sampled, and the initial feature map with the spatial resolution that is half of the spatial resolution of the input image is kept unchanged, and the initial feature map with the spatial resolution that is one quarter of the spatial resolution of the input image is up-sampled twice. So that through the above method, the scales of the initial feature maps of the three scales can be unified to the scale corresponding to the target scale branch. Both up-sampling and down-sampling can be realized through the bilinear interpolation method, so as to reduce computation and improve image processing speed.

Step B, information compression is performed based on the initial fusion map to obtain an information compression vector.

In some embodiments, on the initial fusion map are performed a Global Average Pooling (GAP) processing, a convolution processing and a ReLU activation processing successively to obtain the information compression vector.

Specifically, first, a statistical vector s of a channel dimension can be obtained through the Global Average Pooling processing, and then an information compression vector z can be obtained by performing the convolution processing and the ReLU activation processing on the statistical vector once, and a length of the information compression vector z is smaller than that of the statistical vector s.

Step C, multiple feature vectors carrying attention information are obtained based on the information compression vector, wherein a number of the multiple feature vectors carrying the attention information is same with a number of scale types of the multiple scales.

For example, there are totally three scales mentioned above, and here three feature vectors carrying attention information are obtained. In some embodiments, multiple convolutions can be respectively performed on the information compression vectors several times to expand to expand channels of the information compression vector to obtain multiple expanding feature vectors; and then, a Softmax activation is performed on the multiple extending feature vectors respectively to obtain the multiple feature vectors carrying the attention information. Illustratively, the information compression vector z can pass through three convolutional layers respectively, to expand the channels to obtain three vectors with a same length as the above statistical vector s, namely v1, v2 and v3, and then the activation processing is performed to obtain three new vectors carrying the attention information.

Step D, a fusion processing is performed according to the multiple feature vectors carrying the attention information to obtain the multi-scale fusion map.

In some embodiments, a point multiplication can be performed respectively on each of the feature vectors carrying the attention information and the initial feature map of a scale corresponding to the each of the feature vectors to obtain a point multiplication result corresponding to each scale; point multiplication results corresponding to multiple scales respectively are summed to obtain the multi-scale fusion map. Through the above-mentioned step-by-step fusion method, the multi-scale fusion image final obtained can fully and effectively reflect the image features, facilitating to achieve a better image enhancement effect subsequently.

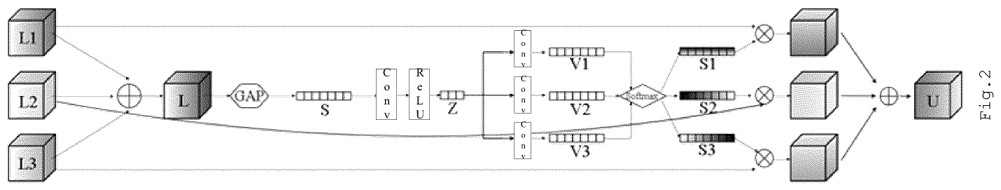

In a practical application, the above steps A to D can be executed by using a selective feature fusion module. The embodiments of the present disclosure provide an elementary diagram of the selective feature fusion module as shown in FIG. 2, and each of the scale branches can be provided with a selective feature fusion module. Taking three scales as an example, selective feature fusion steps can be implemented with reference to the following 1) to 6).

1) Inputs of a selective feature fusion module are initial feature maps of three different scales (spatial resolutions), and feature maps obtained after unifying scales of the inputs with a scale of a target scale branch where the selective feature fusion module is located, are L1, L2 and L3 respectively, which are fused through an element-wise sum to obtain L=L1+L2+L3, where L is the aforementioned initial fusion map.

2) A statistical vector s of a channel dimension can be obtained by performing Global Average Pooling (GAP) on L, where S=GAP (L).

3) A convolution and an activation processing is performed once on the statistical vector s for information compression to obtain a vector z, where z=ReLU (Conv(s)) is the aforementioned information compression vector, and a length of z is less than that of s.

4) Vector z passes through the three convolutional layers respectively to expand the channels to obtain three vectors v1, v2 and v3 with the same length as vector s, where vi=convᵢ (z), and i=1, 2 and 3. vi is the aforementioned expanding feature vector.

5) A Softmax activation processing is performed on v1, v2 and v3 respectively to obtain three new vectors s1, s2 and s3 carrying attention information, where si=Softmax (vi) and i=1, 2 and 3;

6) The point multiplication results of s1, s2 and s3 carrying attention information and the three feature maps L1, L2 and L3 respectively, are summed to obtain an output feature map U of the selective feature fusion module, where U=Σᵢ₌₁³ si·Li. U is the aforementioned multi-scale fusion map.

The traditional attention mechanism can only process features of a single scale, but the selective feature fusion module provided in the embodiments of the present disclosure uses the self-attention mechanism to process the feature maps of different scales, and fuse the feature maps of different scales based on the attention mechanism, thereby realizing a dynamic combination of multi-scale features in a targeted way based on image content. The above is only an illustrative explanation and should not be construed as a limitation. In a practical application, the adopted scale types may not be limited to three, and in addition, the steps in 1) to 6) above can be adjusted adaptively.

In order to extract more useful feature information and further improve an effect of the image quality enhancement, in a specific implementation of the above step 2 (that is, obtaining the intermediate feature map corresponding to the target scale branch based on the multi-scale fusion map), the multi-scale fusion map corresponding to the target scale branch can be processed based on the attention mechanism to obtain the intermediate feature map corresponding to the target scale branch. That is, on the basis of obtaining the multi-scale fusion map fusing features of different resolutions, the attention mechanism is further adopted to further extract feature information inside the multi-scale fusion map. The attention mechanism can suppress features that are relatively not particularly important (useful) to a task and give them a small weight, while at the same time enhancing features that are useful to the task and giving them a large weight. In this way, effective features in an image can be further extracted and the image quality can be further improved.

Illustratively, for each target scale branch, the method of processing the multi-scale fusion map corresponding to the target scale branch based on the attention mechanism can be implemented with reference to the following steps a to d.

Step a, a deep feature extraction is performed on the multi-scale fusion map corresponding to the target scale branch to obtain a deep feature map.

In some embodiments, the multi-scale fusion map corresponding to the target scale branch can be subjected to a first convolution processing, a ReLU activation processing and a second convolution processing successively to obtain the deep feature map. Through step a, firstly the deep feature extraction is performed on the multi-scale fusion map.

Step b, the deep feature map is processed based on a spatial attention mechanism to obtain a spatial attention feature map. In some embodiments, it can be implemented by referring to the following steps b1 to b3:
step b1, a Global Average Pooling (GAP) is performed on the deep feature map in a channel dimension to obtain a first feature map, and a Global Max Pooling (GMP) is performed on the deep feature map in the channel dimension to obtain a second feature map;
step b2, a cascade operation is performed on the first feature map and the second feature map to obtain a cascade feature map, wherein the cascade feature map has two channels;
step b3, a dimension compression processing and an activation processing are performed on the cascade feature map to obtain the spatial attention feature map.

Step c, the deep feature map is processed based on a channel attention mechanism to obtain a channel attention vector. In some embodiments, it can be implemented by referring to the following steps c1 to c3:
step c1, a Global Average Pooling (GAP) operation is performed on the deep feature map in a spatial dimension to obtain a first vector;
step c2, a convolution processing and a ReLU activation processing are performed on the first vector to obtain a second vector, wherein a dimension of the second vector is smaller than that of the first vector;
step c3, a convolution processing and a Sigmoid activation processing are performed on the second vector to obtain a channel attention vector, wherein a dimension of the channel attention vector is equal to that of the first vector.

Step d, a fusion processing is performed based on the deep feature map, the spatial attention feature map and the channel attention vector to obtain the intermediate feature map corresponding to the target scale branch.

After obtaining the spatial attention feature map based on a spatial attention mechanism and the channel attention vector based on a channel attention mechanism, the intermediate feature map corresponding to the target scale branch can be obtained by further combining the deep feature map with the spatial attention feature map and the channel attention vector. In some embodiments, it can be implemented by referring to the following steps d1 to d3:
step d1, a point multiplication of the deep feature map and the spatial attention feature map is performed to obtain a first point multiplication result;
step d2, point multiplication of the deep feature map and the channel attention vector is performed to obtain a second point multiplication result;
step d3, a fusion processing is performed according to the first point multiplication result and the second point multiplication result to obtain the intermediate feature map corresponding to the target scale branch. Illustratively, the first point multiplication result and the second point multiplication result can be cascaded to obtain a two-channel feature map; then a convolution processing is performed on the two-channel feature map to obtain a one-channel feature map. After that, the one-channel feature map is added to the multi-scale fusion map corresponding to the target scale branch to obtain the intermediate feature map corresponding to the target scale branch.

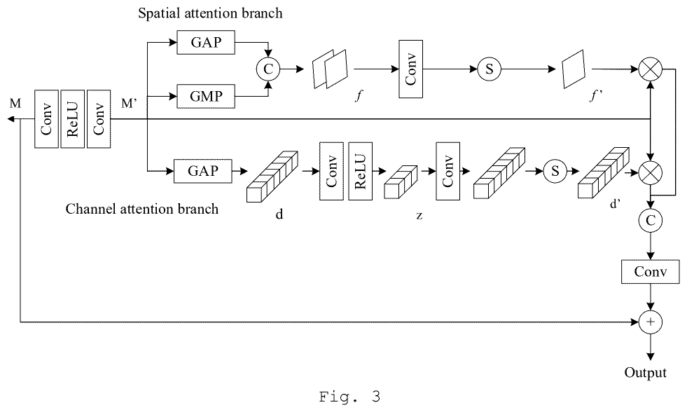

In a practical application, an attention module can be used to execute the above step a to step d, and each scale branch can be provided with an attention module, which is connected in series after the above-mentioned selective feature fusion module. The embodiments of the present disclosure provide an elementary diagram of the attention module as shown in FIG. 3, and the attention module can process a feature map M (that is, the above-mentioned multi-scale fusion map U) output by the selective feature fusion module with reference to the following 1) to 6).

1) The feature map M is subjected to a convolution processing (indicated by Conv in FIG. 3), a ReLU activation processing and another convolution processing to obtain a feature map M′, where M′=Conv (ReLU (Conv (M))). Namely, M′ is the aforementioned deep feature map.

After that, M′ enters two branches (a channel attention branch and a spatial attention branch) respectively.

2) In the spatial attention branch, a GAP processing and a GMP processing are respectively performed on M′ in the channel dimension, and two obtained feature maps are cascaded (indicated by C in FIG. 3) to obtain a feature map f with two channels, where f=Concat (GAP (M′), GMP (M′)), and f is the aforementioned cascade feature map (two-channel feature map). After that, a convolution is performed on the feature map f, so as to compress a dimension and obtain a one-channel feature map, and a feature map f′ can be obtained by a Sigmoid activation function (indicated by S in FIG. 3), where f′=Sigmoid (Conv(f)). The feature map f′ is the aforementioned spatial attention feature map.

3) In the channel attention branch, a GAP processing is performed on M′ in the spatial dimension to obtain a vector d, where d=GAP (M′), and d is the aforementioned first vector. Then, the vector d is subjected to a convolution and a ReLU activation function successively for compressing a dimension to obtain a vector z; that is, the dimension of the vector z is smaller than that of vector d, and z-ReLU (Conv (d)), where z is the aforementioned second vector. After that, the vector z is expanded in dimension by a convolution and a Sigmoid, to obtain a vector d′ with the same length as the vector d, where d′=Sigmoid (Conv (z)) and d′ is the aforementioned channel attention vector.

4) A point Multiplication of the spatial attention feature map f′ the feature map M′ in 1) and a point Multiplication of the channel attention vectors d′ and the feature map M′ in 1) are performed respectively and point Multiplication results are cascaded to obtain a two-channel feature map L=Concat (M′*f′, M′*d′).

5) L is converted to a one-channel feature map after a layer of convolution, and then added with the above feature map M to obtain an output feature map O=M+Conv(L) of the attention module. O is the aforementioned intermediate feature map.

The above is only an illustrative explanation and should not be construed as limitation.

After the multiple intermediate feature maps are obtained in the above manner, a fusion can be performed based on the multiple intermediate feature maps to obtain the output feature map of the multi-scale feature fusion network. In a specific implementation, it is implemented referring to the following step 1˜step 2.

Step 1, the multiple intermediate feature maps are fused to obtain a fusion feature map. Illustratively, the intermediate feature maps corresponding to different scale branches are fused to obtain a fusion feature map, wherein a scale of the fusion feature map is the same as that of the input image of the multi-scale feature fusion network. In some embodiments, a mode of fusing the multiple intermediate feature maps is the same as a mode of fusing the initial feature maps of the multiple scales, for example, both of them can be realized by using the selective feature fusion module provided in FIG. 2.

Step 2, an element-wise sum fusion is performed based on the fusion feature map and the input feature map of the multi-scale feature fusion network to obtain the output feature map of the multi-scale fusion feature network. In a specific implementation, the fusion feature map is first subjected to a convolution processing, and a feature map obtained after the convolution processing and the input image are subjected to the element-wise sum fusion to obtain the output feature map of the multi-scale feature fusion network.

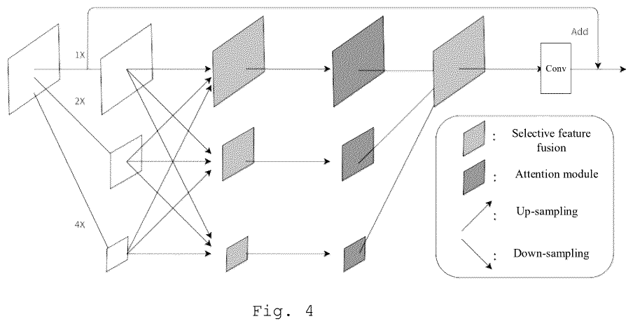

In order to facilitate understanding, on the basis of the above description, some embodiments of the present disclosure provide a structural diagram of a multi-scale feature fusion network as shown in FIG. 4. In FIG. 4, three scale branches are simply illustrated, which are scale branches corresponding to the initial feature maps of three scales obtained by perform one-time down-sampling, twice down-sampling and four times down-sampling on the input image respectively. The above scales can be used to characterize spatial resolutions of feature maps. The feature maps of three scales respectively are: the initial feature map with the a spatial resolution that is same as the input image, the initial feature map with a spatial resolution that is half of the spatial resolution of the input image, and the initial feature map with a spatial resolution that is one quarter of the spatial resolution of the input image. As shown schematically in FIG. 4, each scale branch comprises a selective feature fusion module and an attention module. Finally, all output feature maps of the attention module can be fused by the selective feature fusion module again on a first scale branch to obtain a feature map with a same scale as the input image. Further, FIG. 4 also shows that after fusing the intermediate feature maps corresponding to different scale branches to obtain the fusion feature map, the fusion feature map, after convolution processing, is subjected to an element-wise sum fusion with the input image of the multi-scale feature fusion network, to obtain the output feature map of the multi-scale feature fusion network. In addition, FIG. 4 is only an illustrative explanation and should not be construed as a limitation.

For each multi-scale feature fusion network in the image enhancement model, the output feature map can be obtained in the above manner. In the case where a number of the multi-scale feature fusion networks is multiple and they are connected in series successively, multi-scale feature fusions can be performed from front to back for many phases to gradually obtain the output feature map of the last multi-scale feature fusion network. On this basis, obtaining an image of which an image quality is enhanced based on the output feature map of the multi-scale feature fusion network and the initial image comprises: performing a fusion based on the output feature map of the last multi-scale feature fusion network and the initial image to obtain the image of which the image quality is enhanced. In a specific implementation, the output feature map of the last multi-scale feature fusion network can be subjected to a convolution processing to make its dimension the same as that of the initial image, and then fused with the initial image through an element-wise sum fusion to obtain the image of which the image quality is enhanced.

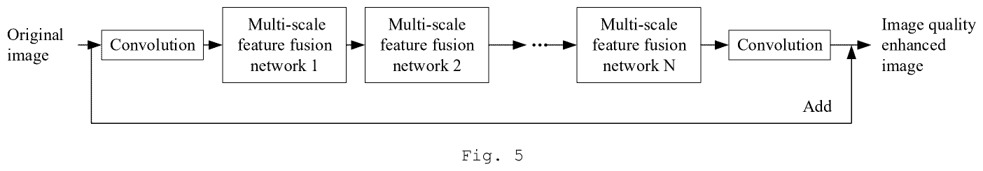

On the basis of the above description, referring to a schematic structural diagram of an image enhancement model provided in some embodiments of the present disclosure as shown in FIG. 5, the initial image is processed by N multi-scale feature fusion networks, wherein a fusion is gradually achieved inside each multi-scale feature fusion network, and successively fused by multiple multi-scale feature fusion networks, so that the image quality can be gradually improved, and finally a better quality enhanced image can be obtained.

In order to speed up a network operation and reduce the number of network parameters, in some embodiments, a convolution in the image enhancement model is 3*3 depth-wise separable convolution and/or 1*1 convolution. For example, all convolutions 3*3 depth-wise separable convolution, or all convolutions use 1*1 convolution, or some convolutions use 3*3 depth-wise separable convolution and some convolutions use 1*1 convolution. In addition, both down-sampling and up-sampling involved in the image enhancement model adopt bilinear interpolation. In the above manner, the image enhancement model can be light-weighted, the network parameters can be significantly reduced, a computation can be effectively decreased, and the network operation speed can be well improved.

Further, some embodiments of the present disclosure provide a training method for the image enhancement model. Specifically, the image enhancement model is obtained by training according to the following steps (1) to (2).

Step (1), training sample pairs are obtained, wherein each of the training sample pairs comprises an image quality enhanced sample and an image quality degraded sample with consistent image content, and a number of the training sample pairs is multiple.

In some embodiments, image samples may be obtained first; then, a degradation processing is performed on the image samples according to specified dimensions to obtain image quality degraded samples. The specified dimensions comprise more than one of clarity, color, contrast and noise; and the image samples are used as the image quality enhancement samples, or the image samples are subjected to an enhancement processing according to specified dimensions to obtain the image quality enhancement samples.

The embodiments of the present disclosure do not limit methods of obtaining the image samples, such as by directly capturing images through a camera, directly obtaining images through a network, or adopting images in an existing image library or sample library. After that, the image samples can be degraded according to various dimensions, such as reducing the clarity, color, contrast and the like of the image samples, or adding noise to the image samples, so as to obtain the image degraded samples. In a practical application, in a case where a quality of the image samples is good, the image samples can be directly used as the image quality enhanced samples; in a case where a quality of the image samples are average, the image samples can be enhanced by an existing image optimization algorithm or an image processing tool such as photoshop to obtain the image quality enhanced samples.

Step (2), a neural network model pre-built are trained based on the training sample pairs and a preset loss function, and the trained neural network model is taken as the image enhancement model.

Illustratively, a loss function can be a L1 loss function. When the loss function value converges to a threshold, it can be determined that the training of the neural network model is completed. The trained neural network model can obtain expected images of which the image quality is enhanced (with little difference from the image quality enhanced samples) by processing the image quality degraded samples. The image enhancement model obtained in the above manner can better perform a multi-dimensional image quality enhancement on an image to be processed in to achieve a better image enhancement effect.

In the process of training, the quality degraded samples in the training sample pairs are used as initial images and input into the pre-built neural network model, wherein the neural network model comprises a multi-scale feature fusion network; a multi-scale feature extraction is performed on input images through the multi-scale feature fusion network to obtain initial feature maps of multiple scales; a fusion is performed based on the initial feature maps of the multiple scales to obtain multiple intermediate feature maps, and a fusion is performed based on the multiple intermediate feature maps to obtain output feature maps of the multi-scale feature fusion network, wherein the input images are obtained based on the initial images; images of which an image quality is enhanced are obtained based on the output feature maps of the multi-scale feature fusion network and the initial images; a loss function is determined according to the images of which an image quality is enhanced and the image quality enhanced samples, and parameters of the neural network model are adjusted according to the loss function, and the image enhancement model is obtained. In the process of processing images through the multi-scale feature fusion network can refer to the previous embodiments, and will not be repeated here anymore.

In summary, through the above image enhancement method provided in the embodiments of the present disclosure, a down-sampling can be performed on the initial image in an appropriate degree by using an end-to-end image enhancement model to extract multi-scale features, and a better image enhancement effect can be achieved through a gradual fusion processing within the multi-scale feature fusion network and among multiple multi-scale feature fusion networks. Moreover, by optimizing structures and parameters of the networks, the networks can be light-weighted, a computation of the networks can be effectively reduced, an image processing speed can be increased, and a high real-time performance (30 FPS) can be achieved. In addition, a method of training the model in multiple dimensions simultaneously can allow the model to enhance multiple image quality dimensions at the same time, which is more convenient and fast.

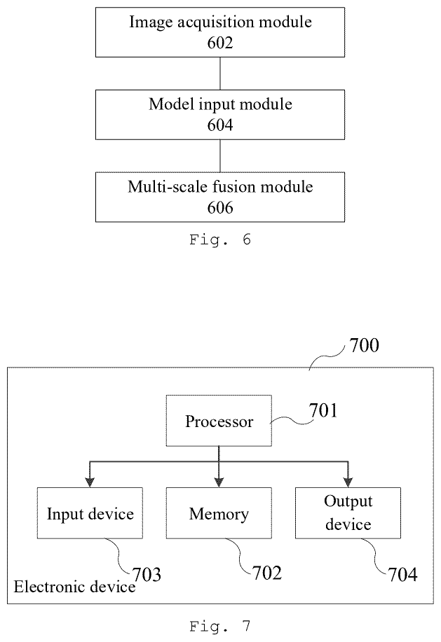

Corresponding to the aforementioned image enhancement method, the embodiments of the present disclosure provide an image enhancement apparatus. FIG. 6 is a schematic structural diagram of an image enhancement apparatus provided in some embodiments of the present disclosure. The apparatus can be realized by software and/or hardware, and can generally be integrated into an electronic device, as shown in FIG. 6, comprising: an image acquisition module 602, a model input module 604, a multi-scale fusion module 606, and an enhanced image acquisition module 608.

The image acquisition module 602 is configured to obtain an initial image to be processed.

The model input module 604 is configured to input the initial image into an image enhancement model obtained by pre-training, wherein the image enhancement model comprises a multi-scale feature fusion network.

the multi-scale fusion module 606 is configured to perform a multi-scale feature extraction on an input image through the multi-scale feature fusion network to obtain initial feature maps of multiple scales, perform a fusion based on the initial feature maps of the multiple scales to obtain multiple intermediate feature maps, and perform a fusion based on the multiple intermediate feature maps to obtain an output feature map of the multi-scale feature fusion network, wherein the input image is obtained based on the initial image.

the enhanced image acquisition module 608 is configured to obtain an image of which an image quality is enhanced based on the output feature map of the multi-scale feature fusion network and the initial image.

In a manner of performing a gradual fusion based on multi-scale features by the image enhancement apparatus provided in the embodiments of the present disclosure, image features can be fully extracted and utilized, and an image quality can be effectively improved.

In some embodiments, the multi-scale fusion module 606 is specifically configured to perform down-samplings on the input image according to a plurality of preset multiples respectively to obtain the initial feature maps of the multiple scales, wherein the preset multiples are lower than a preset threshold.

In some embodiments, the multi-scale fusion module 606 is specifically configured to: fuse the initial feature maps of the multiple scales under different scale branches respectively to obtain an intermediate feature map corresponding to each of the scale branches, wherein intermediate feature maps corresponding to different scale branches have different spatial resolutions.

In some embodiments, the multi-scale fusion module 606 is specifically configured to: perform a fusion processing on the initial feature maps of the multiple scales based on a self-attention mechanism to obtain a multi-scale fusion map; and take the each of the scale branches as a target scale branch respectively, and obtain an intermediate feature map corresponding to the target scale branch based on the multi-scale fusion map.

In some embodiments, the multi-scale fusion module 606 is specifically configured to: unify scales of the initial feature maps of the multiple scales to a scale corresponding to the target scale branch, and perform an element-wise sum fusion on the initial feature maps after unifying scales to obtain an initial fusion map; performing information compression based on the initial fusion map to obtain an information compression vector; obtain multiple feature vectors carrying attention information based on the information compression vector, wherein a number of the multiple feature vectors carrying the attention information is same with a number of scale types of the multiple scales; and perform a fusion processing according to the multiple feature vectors carrying the attention information to obtain the multi-scale fusion map.

In some embodiments, the multi-scale fusion module 606 is specifically configured to: by bilinear interpolation, unify the scales of the initial feature maps of the multiple scales to the scale corresponding to the target scale branch.

In some embodiments, the multi-scale fusion module 606 is specifically configured to: perform a Global Average Pooling processing, a convolution processing and a ReLU activation processing successively on the initial fusion map to obtain an information compression vector.

In some embodiments, the multi-scale fusion module 606 is specifically configured to: perform multiple convolutions on the information compression vector respectively to expand channels of the information compression vector to obtain multiple expanding feature vectors; and perform a Softmax activation on the multiple extending feature vectors respectively to obtain the multiple feature vectors carrying the attention information.

In some embodiments, the multi-scale fusion module 606 is specifically configured to: respectively perform a point multiplication on each of the feature vectors carrying the attention information and the initial feature map of a scale corresponding to the each of the feature vectors to obtain a point multiplication result corresponding to each scale; sum point multiplication results corresponding to multiple scales respectively to obtain the multi-scale fusion map.

In some embodiments, the multi-scale fusion module 606 is specifically configured to: process the multi-scale fusion map corresponding to the target scale branch based on the attention mechanism to obtain the intermediate feature map corresponding to the target scale branch.

In some embodiments, the multi-scale fusion module 606 is specifically configured to: perform a deep feature extraction on the multi-scale fusion map corresponding to the target scale branch to obtain a deep feature map; process the deep feature map based on a spatial attention mechanism to obtain a spatial attention feature map; process the deep feature map based on a channel attention mechanism to obtain a channel attention vector; and perform a fusion processing based on the deep feature map, the spatial attention feature map and the channel attention vector to obtain the intermediate feature map corresponding to the target scale branch.

In some embodiments, the multi-scale fusion module 606 is specifically configured to: perform a first convolution processing, a ReLU activation processing and a second convolution processing successively on the multi-scale fusion map corresponding to the target scale branch to obtain the deep feature map.

In some embodiments, the multi-scale fusion module 606 is specifically configured to: perform a Global Average Pooling on the deep feature map in a channel dimension to obtain a first feature map, and perform a Global Max Pooling on the deep feature map in the channel dimension to obtain a second feature map; perform a cascade operation on the first feature map and the second feature map to obtain a cascade feature map; and perform a dimension compression processing and an activation processing on the cascade feature map to obtain the spatial attention feature map.

In some embodiments, the multi-scale fusion module 606 is specifically configured to: perform a Global Average Pooling operation on the deep feature map in a spatial dimension to obtain a first vector; perform a convolution processing and a ReLU activation processing on the first vector to obtain a second vector, wherein a dimension of the second vector is smaller than that of the first vector; and perform a convolution processing and a Sigmoid activation processing on the second vector to obtain a channel attention vector, wherein a dimension of the channel attention vector is equal to that of the first vector.

In some embodiments, the multi-scale fusion module 606 is specifically configured to: perform a point multiplication of the deep feature map and the spatial attention feature map to obtain a first point multiplication result; perform a point multiplication of the deep feature map and the channel attention vector to obtain a second point multiplication result; and perform a fusion processing according to the first point multiplication result and the second point multiplication result to obtain the intermediate feature map corresponding to the target scale branch.

In some embodiments, the multi-scale fusion module 606 is specifically configured to: cascade the first point multiplication result and the second point multiplication result to obtain a two-channel feature map; perform a convolution on the two-channel feature map to obtain a one-channel feature map; and add the one-channel feature map and the multi-scale fusion map corresponding to the target scale branch to obtain the intermediate feature map corresponding to the target scale branch.

In some embodiments, the multi-scale fusion module 606 is specifically configured to: fuse the multiple intermediate feature maps to obtain a fusion feature map, wherein a scale of the fusion feature map is same as that of the input image of the multi-scale feature fusion network; and perform an element-wise sum fusion based on the fusion feature map and the input feature map of the multi-scale feature fusion network to obtain the output feature map of the multi-scale feature fusion network.

In some embodiments, a way of performing the fusion based on the initial feature maps is same as a way of performing the fusion based on the multiple intermediate feature maps.

In some embodiments, the initial feature maps of the multiple scales comprise: an initial feature map with a spatial resolution that is same as the input image, an initial feature map with a spatial resolution that is half of the spatial resolution of the input image, and an initial feature map with a spatial resolution that is one quarter of the spatial resolution of the input image.

In some embodiments, an convolution in the image enhancement model is 3*3 depth-wise separable convolution and/or 1*1 convolution.

In some embodiments, a number of the multi-scale feature fusion network is multiple, and the multiple multi-scale feature fusion networks are sequentially connected in series, wherein the input image of a first multi-scale feature fusion network is obtained based on the initial image, and the input image of a non-first multi-scale feature fusion network is obtained based on the output feature map of a previous multi-scale feature fusion network.

In some embodiments, the enhanced image acquisition module 608 is specifically configured to: perform a fusion based on the output feature map of a last multi-scale feature fusion network and the initial image to obtain the image of which an image quality is enhanced.

In some embodiments, the apparatus further comprises a training module, specifically configured to train the image enhancement model according to the following manners: obtain training sample pairs, wherein each of the training sample pairs comprises an image quality enhanced sample and an image quality degraded sample with consistent image content, and a number of the training sample pairs is multiple; and train a neural network model pre-built based on the training sample pairs and a preset loss function, and take the trained neural network model as the image enhancement model.

In some embodiments, the training module is specifically configured to: obtain image samples; perform a degradation processing on each of the image samples according to specified dimensions to obtain the image quality degraded sample, wherein the specified dimensions comprise more than one of clarity, color, contrast and noise; and take the each of the image samples as the image quality enhanced sample, or, perform an enhancement processing on the each of the image samples according to the specified dimensions to obtain the image quality enhanced sample.

The image enhancement apparatus provided in the embodiments of the present disclosure can execute the image enhancement method provided in any embodiment of the present disclosure, and has corresponding functional modules and beneficial effects for executing the method.

It can be clearly understood by those skilled in the art that in order for a convenient and concise description, the specific working process of the device embodiments described above can refer to the corresponding process in the method embodiments, and will not be repeated here.

Some embodiments of the present disclosure provide an electronic device, the electronic device comprising: a processor, a memory for storing executable instructions, wherein the processor is configured to read the executable instructions from the memory, and execute the instructions to implement the image enhancement method as described in any of the above.

FIG. 7 is a schematic structural diagram of an electronic device provided in some embodiments of the present disclosure. As shown in FIG. 7, the electronic device 700 comprises one or more processors 701 and a memory 702.

The processor 701 can be a Central Processing Unit (CPU) or other forms of processing unit with data processing capability and/or instruction execution capability, and can control other components in the electronic device 700 to perform desired functions.

The memory 702 can comprise one or more computer program products, which can comprise various forms of computer-readable storage media, such as volatile memory and/or nonvolatile memory. The volatile memory can comprise, for example, a Random Access Memory (RAM) and/or a cache and the like. The nonvolatile memory can comprise, for example, a Read-Only Memory (ROM), a hard disk, a flash memory, and the like. One or more computer program instructions can be stored on the computer-readable storage medium, and the processor 701 can execute the program instructions to realize the image enhancement method and/or other desired functions of the embodiments of the present disclosure described above. Various content such as input signals, signal components, noise components and the like can also be stored in the computer-readable storage medium.

In one example, the electronic device 700 can further comprise: an input apparatus 703 and an output apparatus 704, which are interconnected by a bus system and/or other forms of connection mechanisms (not shown).

In addition, the input apparatus 703 can further comprise, for example, a keyboard, a mouse, and the like.

The output apparatus 704 can output various information to the outside, comprising determined distance information, direction information, etc. The output apparatus 704 can comprise, for example, a display, a speaker, a printer, and a communication network as well as a remote output apparatus connected thereto.

Of course, for simplicity, only some components related to the present disclosure in the electronic device 700 are shown in FIG. 7, and components such as a bus, an input/output interface and the like are omitted. Besides, according to specific application, the electronic device 700 can also comprise any other suitable components.

In addition to the above methods and devices, an embodiment of the present disclosure can also be a computer program product, which comprises computer program instructions that, when executed by a processor, cause the processor to implement the image enhancement method provided in the embodiments of the present disclosure.

The computer program product can write program codes for performing operations of the embodiments of the present disclosure in any combination of one or more programming languages, comprising object-oriented programming languages such as Java, C++, etc., and conventional procedural programming languages such as “C” or similar programming languages. The program codes can be completely executed on a user computing device, partially executed on a user device, executed as an independent software package, partially executed on the user computing device and partially executed on a remote computing device, or completely executed on the remote computing device or server.

In addition, some embodiments of the present disclosure also provide a computer-readable storage medium on which computer program instructions are stored, which when executed by a processor, cause the processor to implement the image enhancement method provided in the embodiments of the present disclosure.

The computer-readable storage medium can adopt any combination of one or more readable media. The readable medium can be a readable signal medium or a readable storage medium. The readable storage medium can comprise, for example, but not limited to, an electrical, magnetic, optical, electromagnetic, infrared, or semiconductor system, apparatus or component, or any combination thereof. More specific examples (a non-exhaustive list) of the readable storage media comprise: an electrical connection with one or more wires, a portable disk, a hard disk, a Random Access Memory (RAM), a Read-Only Memory (ROM), an Erasable Programmable Read-Only Memory (EPROM or flash memory), an optical fiber, a Portable Compact Disk Read-Only Memory (CD-ROM), an optical storage device, a magnetic storage device, or any suitable combination thereof.

Some embodiments of the present disclosure also provide a computer program product, comprising a computer program/instruction which when executed by a processor, causes the processor to implement the image enhancement method in any embodiment of the present disclosure.

Some embodiments of the present disclosure also provide a computer program, comprising instructions, which when executed by a processor, cause the processor to implement the image enhancement method in any embodiment of the present disclosure.

It should be noted that in this text, relational terms such as “first” and “second” are only used to distinguish one entity or operation from another entity or operation, and do not necessarily require or imply that there is any such actual relationship or order between these entities or operations. Moreover, the terms “comprising”, “including” or any other variation thereof are intended to cover non-exclusive inclusion, so that a process, method, article or device comprising a series of elements comprises not only those elements, but also other elements not explicitly listed or elements inherent to such process, method, article or device. Without further restrictions, an element defined by the phrase “comprising one” does not exclude the existence of other identical elements in the process, method, article or device comprising the element.

What has been described above is only the specific embodiments of the present disclosure, so that those skilled in the art can understand or realize the present disclosure. Multiple modifications to these embodiments will be obvious to those skilled in the art, and the general principles defined herein can be realized in other embodiments without departing from the spirit or scope of the present disclosure. Therefore, the present disclosure is not to be limited to the embodiments described herein, but is to be accorded with the widest scope consistent with the principles and novel features disclosed herein.

1. An image enhancement method, comprising:
obtaining an initial image to be processed;
inputting the initial image into an image enhancement model obtained by pre-training, wherein the image enhancement model comprises a multi-scale feature fusion network;
performing a multi-scale feature extraction on an input image through the multi-scale feature fusion network to obtain initial feature maps of multiple scales, performing a fusion based on the initial feature maps of the multiple scales to obtain multiple intermediate feature maps, and performing a fusion based on the multiple intermediate feature maps to obtain an output feature map of the multi-scale feature fusion network, wherein the input image is obtained based on the initial image; and
obtaining an image of which an image quality is enhanced based on the output feature map of the multi-scale feature fusion network and the initial image.

2. The image enhancement method according to claim 1, wherein the performing a multi-scale feature extraction on an input image through the multi-scale feature fusion network to obtain initial feature maps of multiple scales comprises:
performing down-samplings on the input image according to a plurality of preset multiples respectively to obtain the initial feature maps of the multiple scales, wherein the preset multiples are lower than a preset threshold.

3. The image enhancement method according to claim 1, wherein the performing a fusion based on the initial feature maps of the multiple scales to obtain multiple intermediate feature maps comprises:
fusing the initial feature maps of the multiple scales under different scale branches respectively to obtain an intermediate feature map corresponding to each of the scale branches, wherein intermediate feature maps corresponding to different scale branches have different spatial resolutions.

4. The image enhancement method according to claim 3, wherein the fusing the initial feature maps of the multiple scales under different scale branches respectively to obtain an intermediate feature map corresponding to each of the scale branches comprises:
performing a fusion processing on the initial feature maps of the multiple scales based on a self-attention mechanism to obtain a multi-scale fusion map; and
taking the each of the scale branches as a target scale branch respectively, and obtaining an intermediate feature map corresponding to the target scale branch based on the multi-scale fusion map.

5. The image enhancement method according to claim 4, wherein the performing a fusion processing on the initial feature maps of the multiple scales based on a self-attention mechanism to obtain a multi-scale fusion map comprises:
unifying scales of the initial feature maps of the multiple scales to a scale corresponding to the target scale branch, and performing an element-wise sum fusion on the initial feature maps after unifying scales to obtain an initial fusion map;
performing information compression based on the initial fusion map to obtain an information compression vector;
obtaining multiple feature vectors carrying attention information based on the information compression vector, wherein a number of the multiple feature vectors carrying the attention information is same with a number of scale types of the multiple scales; and
performing a fusion processing according to the multiple feature vectors carrying the attention information to obtain the multi-scale fusion map.

6. The image enhancement method according to claim 5, wherein the obtaining multiple feature vectors carrying attention information based on the information compression vector comprises:
performing multiple convolutions on the information compression vector respectively to expand channels of the information compression vector to obtain multiple expanding feature vectors; and
performing a Softmax activation on the multiple extending feature vectors respectively to obtain the multiple feature vectors carrying the attention information.

7. The image enhancement method according to claim 4, wherein the obtaining an intermediate feature map corresponding to the target scale branch based on the multi-scale fusion map comprises:
processing the multi-scale fusion map corresponding to the target scale branch based on the attention mechanism to obtain the intermediate feature map corresponding to the target scale branch.

8. The image enhancement method according to claim 7, wherein the processing the multi-scale fusion map corresponding to the target scale branch based on the attention mechanism to obtain the intermediate feature map corresponding to the target scale branch comprises:
performing a deep feature extraction on the multi-scale fusion map corresponding to the target scale branch to obtain a deep feature map;
processing the deep feature map based on a spatial attention mechanism to obtain a spatial attention feature map;
processing the deep feature map based on a channel attention mechanism to obtain a channel attention vector; and
performing a fusion processing based on the deep feature map, the spatial attention feature map and the channel attention vector to obtain the intermediate feature map corresponding to the target scale branch.

9. The image enhancement method according to claim 8, wherein the processing the deep feature map based on a spatial attention mechanism to obtain a spatial attention feature map comprises:
performing a Global Average Pooling on the deep feature map in a channel dimension to obtain a first feature map, and performing a Global Max Pooling on the deep feature map in the channel dimension to obtain a second feature map;
performing a cascade operation on the first feature map and the second feature map to obtain a cascade feature map; and
performing a dimension compression processing and an activation processing on the cascade feature map to obtain the spatial attention feature map.

10. The image enhancement method according to claim 8, wherein the performing a fusion processing based on the deep feature map, the spatial attention feature map and the channel attention vector to obtain the intermediate feature map corresponding to the target scale branch comprises:
performing a point multiplication of the deep feature map and the spatial attention feature map to obtain a first point multiplication result;
performing a point multiplication of the deep feature map and the channel attention vector to obtain a second point multiplication result; and
performing a fusion processing according to the first point multiplication result and the second point multiplication result to obtain the intermediate feature map corresponding to the target scale branch.

11. The image enhancement method according to claim 10, wherein the performing a fusion processing according to the first point multiplication result and the second point multiplication result to obtain the intermediate feature map corresponding to the target scale branch comprises:
cascading the first point multiplication result and the second point multiplication result to obtain a two-channel feature map;
performing a convolution on the two-channel feature map to obtain a one-channel feature map; and
adding the one-channel feature map and the multi-scale fusion map corresponding to the target scale branch to obtain the intermediate feature map corresponding to the target scale branch.

12. The image enhancement method according to claim 1, wherein the performing a fusion based on the multiple intermediate feature maps to obtain an output feature map of the multi-scale feature fusion network comprises:
fusing the multiple intermediate feature maps to obtain a fusion feature map, wherein a scale of the fusion feature map is same as that of the input image of the multi-scale feature fusion network; and
performing an element-wise sum fusion based on the fusion feature map and the input feature map of the multi-scale feature fusion network to obtain the output feature map of the multi-scale feature fusion network.

13. The image enhancement method according to claim 12, wherein a way of performing the fusion based on the initial feature maps is same as a way of performing the fusion based on the multiple intermediate feature maps.

14. The image enhancement method according to claim 1, wherein a number of the multi-scale feature fusion network is multiple, and the multiple multi-scale feature fusion networks are sequentially connected in series, wherein the input image of a first multi-scale feature fusion network is obtained based on the initial image, and the input image of a non-first multi-scale feature fusion network is obtained based on the output feature map of a previous multi-scale feature fusion network.

15. The image enhancement method according to claim 1, wherein the image enhancement model is trained according to the following method:
obtaining training sample pairs, wherein each of the training sample pairs comprises an image quality enhanced sample and an image quality degraded sample with consistent image content, and a number of the training sample pairs is multiple; and
training a neural network model pre-built based on the training sample pairs and a preset loss function, and taking the trained neural network model as the image enhancement model.

16. The image enhancement method according to claim 15, wherein the obtaining training sample pairs comprises:
obtaining image samples;
performing a degradation processing on each of the image samples according to specified dimensions to obtain the image quality degraded sample, wherein the specified dimensions comprise more than one of clarity, color, contrast and noise; and
taking the each of the image samples as the image quality enhanced sample, or, performing an enhancement processing on the each of the image samples according to the specified dimensions to obtain the image quality enhanced sample.

17. (canceled)

18. An electronic device, wherein the electronic device comprises:
a processor, and
a memory for storing executable instructions of the processor,
wherein the processor is configured to read the executable instructions from the memory, and execute the executable instructions to:
obtain an initial image to be processed;
input the initial image into an image enhancement model obtained by pre-training, wherein the image enhancement model comprises a multi-scale feature fusion network;
perform a multi-scale feature extraction on an input image through the multi-scale feature fusion network to obtain initial feature maps of multiple scales, perform a fusion based on the initial feature maps of the multiple scales to obtain multiple intermediate feature maps, and perform a fusion based on the multiple intermediate feature maps to obtain an output feature map of the multi-scale feature fusion network, wherein the input image is obtained based on the initial image; and
obtain an image of which an image quality is enhanced based on the output feature map of the multi-scale feature fusion network and the initial image.

19. A non-transitory computer-readable storage medium, wherein
the storage medium stores computer programs, which when executed by a processor, cause the processor to:
obtain an initial image to be processed;
input the initial image into an image enhancement model obtained by pre-training, wherein the image enhancement model comprises a multi-scale feature fusion network;
perform a multi-scale feature extraction on an input image through the multi-scale feature fusion network to obtain initial feature maps of multiple scales, perform a fusion based on the initial feature maps of the multiple scales to obtain multiple intermediate feature maps, and perform a fusion based on the multiple intermediate feature maps to obtain an output feature map of the multi-scale feature fusion network, wherein the input image is obtained based on the initial image; and
obtain an image of which an image quality is enhanced based on the output feature map of the multi-scale feature fusion network and the initial image.

20. (canceled)

21. The electronic device according to claim 18, wherein the performing a multi-scale feature extraction on an input image through the multi-scale feature fusion network to obtain initial feature maps of multiple scales comprises:
performing down-samplings on the input image according to a plurality of preset multiples respectively to obtain the initial feature maps of the multiple scales, wherein the preset multiples are lower than a preset threshold.

22. The electronic device according to claim 18, wherein the performing a fusion based on the initial feature maps of the multiple scales to obtain multiple intermediate feature maps comprises:
fusing the initial feature maps of the multiple scales under different scale branches respectively to obtain an intermediate feature map corresponding to each of the scale branches, wherein intermediate feature maps corresponding to different scale branches have different spatial resolutions.
